(19) United States
(12) Patent Application Publication
(10) Pub. No.: US 2026/0093246 A1
(43) Pub. Date: Apr. 2, 2026

(54) Method for Configuring Operator Training System

(71) Applicant: Siemens Aktiengesellschaft, Muenchen (DE)

(72) Inventors: Benjamin LUTZ, Pfinztal (DE); Gerrit WOLF, Stutensee (DE)

(21) Appl. No.: 19/341,163

(22) Filed: Sep. 26, 2025

(30) Foreign Application Priority Data
Sep. 27, 2024 (EP) 24203279

(51) Int. Cl. G05B 19/418; G09B 19/00

(52) U.S. Cl. CPC G05B 19/41885; G09B 19/00

(57) ABSTRACT

A method includes creating a first configuration for a first group of real automation devices of a technical plant, allocating the first configuration to the first group of real automation devices, transmitting the first configuration to the first group of real automation devices, creating a second configuration for a second group of real automation devices different from the first group, allocating the second configuration to the second group of real automation devices, transmitting the first configuration to the second group of real automation devices, additionally allocating the first configuration to a first group of virtual automation devices, transmitting the allocated first configuration to a virtualization environment, which provides the first group of virtual automation devices, additionally allocating the second configuration to the first group of virtual automation devices, and transmitting the allocated first configuration to the virtualization environment, which provides the first group of virtual automation devices.

### BACKGROUND OF THE INVENTION

### 1. Field of the Invention

The invention relates to an automation system, a method and a computer-implemented tool for creating an automation for a technical plant, in particular a process or production plant.

### 2. Description of the Related Art

Modern process engineering systems, and also the automation systems belonging to them, are becoming ever more comprehensive, larger and more complex. This requires training the system operators in a manner that is as close to reality, as frequent and as knowledgeable as possible. Very high rates of failure of production capacities, but also the occurrence of accidents, are not infrequently attributable to incorrect operation by operators. Therefore in particular plants that are subject to safety and availability conditions possess an Operator Training System (OTS). This is employed for training of new personnel, new parts of the system and functions, but above all also for regularly keeping knowledge up to date. In such cases, there is training for both regular but also for unknown production scenarios.

It is standard practice for the training system to create a map of the automation of the real plant. Here, the automation devices and operator station servers used in the real system are set up as duplicates, so that the operator can move around in a familiar environment and the behavior of the automation corresponds exactly to the expected behavior of the real technical plant. In order to make this possible, one requirement of the training system consists of being consistent with the productive system or of corresponding to the real system map. However, changes, maintenance procedures and improvements are constantly being implemented on the system, which, in combination with the wear processes within the system, can change the behavior of the real technical plant by comparison with the training system.

Typically, operators are trained before they are allowed to operate and look after the real plant. Here, they are trained not only for regular operation but in particular also for diverse exception situations, which are included as part of the training. The training is undertaken by the Operator Training System, which essentially is made up of the same automation components (e.g., operator station server, and/or automation devices) as the real system. Only the actual (process engineering) process, which executes on the system is replaced by a simulation model. The simulation model is also used in order to be able to explicitly include exception situations for training purposes. Numerous “duplicates” of the real system arise here for operator training in relation to the automations and operator station servers used. This leads to the following problems:
preserving the consistency between productive plant and training system in the life cycle,
high degree of maintenance and upkeep of the training system necessary, in particular when project planning changes are made during ongoing operation, which must first be verified (as relevant) and correspondingly made in the training system,
scalability restricted, because a training system mostly corresponds to the map of a productive plant, even if only one dedicated part of the plant were required for specific training,
updating of the training system necessary by separate training personnel/individuals responsible. As a rule, the use of the OTS makes no sense when it is no longer being supported and maintained. The automation on the other hand is regularly maintained and revised.
necessary simplifications in order to train for specific scenarios and “exclude” other parts. This is often very complex, because operators, process engineers and automation engineers are required to reach a common understanding for a training situation. As an example, characteristics for increasing the availability (redundantly designed devices) are completely neglected in a training system.
need for devices, because almost the same range of devices are needed for each training system as for the productive plant.

EP 3 151 217 A1 discloses an engineering system of a control system, in which automation configurations can be assigned either to real automation devices or to virtual automation devices. This engineering system cannot overcome the above-described disadvantages.

### SUMMARY OF THE INVENTION

In view of the foregoing, it is therefore an object of the invention to provide a computer-implemented tool for creating an automation that overcomes the above-described disadvantages and that makes possible an efficient and exact training for operators of control systems of technical plants.

These and other objects and advantages are achieved in accordance with the invention by an automation system, a method, use of the automation system for training an operator and by a computer-implemented tool for creating an automation for a technical plant, in particular a process or production, which is configured to create a first configuration for a first group of real automation devices used in the technical plant, to allocate the configuration to the first group of real automation devices used in the technical plant and to transmit the configuration to the first group of real automation devices used in the technical plant, and to create a second configuration for a second group of real automation devices, different from the first group, used in the technical plant, to allocate the second configuration to the second group of real automation devices used in the technical plant and to transmit the second configuration to the second group of real automation devices used in the technical plant.

An automation is understood as the capability of automation devices to autonomously (automatically) detect and influence physical variables with the aid of technical means. In such cases, as a rule machines, plants or other facilities are given the capability to work independently. “Automation” comprises at least a parameterization of the components of the system and an interaction between the components and other components.

The technical plant can involve a plant from the process industry, such as a chemical, pharmaceutical, petrochemical plant or a plant from the foodstuffs, drinks and tobacco industry. Also included in this are any plants from the production industry, works in which, for example, autos or goods of all types are produced. Technical plants that are suitable for implementing the inventive method can also come from the area of energy generation. Wind turbines, solar systems or power plants for energy generation are also covered by the term technical plant.

The computer-implemented tool, which can be implemented for example on an engineering station server of a control system for the technical plant, is in other words configured to create at least two different configurations and to allocate them to at least two groups of automation devices. Automation devices are used in this case for realization of an automation and can, for example, be programmable logic controllers or control systems, which represent a higher-ranking control function for subordinate programmable logic controllers. The various groups in this case can have shared (real) automation devices, thus intersections can exist. It should be understood, however, that the groups differ from one another, at least with respect to an automation device.

The configurations created, allocated and transmitted can involve, with being restricted thereto, system maps, Continuous Function Chart-Based (CFC-based) plans, Sequential Function Chart-Based (SFC-based) plans, process objects and/or connectivity objects. Connectivity objects in this case involve specific interfaces that make it possible to integrate various systems and devices into a control system. They establish communication between the control system and external devices or systems such as programmable logic controllers (PLC), field devices or other control systems. Examples of this are an Open Platform Communications (OPC) or a Profibus interface. Process objects are software representations of real system components and processes. They serve to simplify and standardize the control and monitoring of industrial processes. Process objects can be formed as functional modules, for example, which represent prefabricated software modules for specific open-loop and closed-loop control tasks.

The computer-implemented tool is inventively configured, to allocate the first configuration in addition to a first group of virtual automation devices and to transmit the allocated first configuration to a computer-implemented virtualization environment, which provides the first group of virtual automation devices, and to allocate the second configuration in addition to the first group of virtual automation devices and to transmit the allocated first configuration to the computer-implemented virtualization environment, which provides the first group of virtual automation devices.

With the virtual automation devices, the various groups can also have common (virtual) automation devices, thus intersections can exist. It should be understood, however, that the groups differ from one another at least with respect to a (virtual) automation device.

The virtual automation devices will be made available by a virtualization environment that is suitable and configured for this, such as the simulation platform SIMIT from Siemens. The correspondingly configured automation devices can be used as a training system for training operators of a control system.

The inventive computer-implemented tool makes it possible in this case for the virtual training systems to be able to be planned jointly (for operators) and, with respect to the configuration, differing from the productive system (the real, configured automation devices) in a central engineering facility. For the purposes of modularization, reliability and expandability of technical plants the training systems often have significantly more automation devices (and where necessary operator station servers) than are necessary for operation. Specifically and flexibly, with the aid of the inventive computer-implemented tool the automation devices necessary and above all sufficient for training purposes-even for different training systems (different training scenarios for the same productive plant) can be defined and allocated in parallel.

The invention makes it possible, under the precondition of undertaking differing allocations of the virtual automation devices in relation to the productive, real automation devices, to be able to make use of the resource advantage of virtual automations. Virtual automations are capable of executing on conventional servers and are “unrestricted” with respect to memory requirements. Even if to a certain extent the real time capability can be restricted when the servers are “overloaded”, this has no negative aftereffects because, in the simulation and thus also in the training systems, operation is with virtual time slices.

Preferably, the computer-implemented tool is configured to establish a status of the respective transmission of the configurations to the real and virtual automation devices and show it visually. This makes it possible in a simple, intuitive manner to recognize whether inconsistencies exist between the transmission/load status of the real automation devices and that of the virtual automation devices. Hereupon, the operator or the project planner of the control system can take adequate measures.

The invention is not restricted to the computer-implemented tool allocating the first and second configuration to the first group of automation devices. Instead, it can be established to allocate the first or the second configuration additionally to a second group of virtual automation devices different from the first group and to transmit the allocated first configuration or second configuration to the computer-implemented virtualization environment, which provides the first group and the second group of virtual automation devices.

The objects and advantages are also achieved in accordance with the invention by an automation system, comprising an engineering station server with a computer-implemented tool implemented thereon, which is configured as previously explained, and a virtualization computer with a computer-implemented virtualization environment thereon.

An “engineering station server” is understood here as a server that is configured to create, manage, archive and document various hardware and software projects for a control system of a technical plant. With the aid of specific computer-implemented software design tools (engineering toolset) as well as prefabricated modules and plans, an interplay between control devices and facilities of the technical plant can be planned and managed via the engineering station server. An example of this is a SIMATIC Manager Server from SIEMENS.

A virtualization computer can be a standard PC or a computer, which includes processor and memory, and which is configured specifically for the virtualization of automation devices. The virtualization environment implemented on it can be a part of the Siemens SIMIT simulation platform, for example.

Preferably, the virtualization computer is configured in this case to use the configurations transferred from the engineering station server to the virtualization computer to operate the virtual automation devices.

The operation and monitoring of the automated automation devices or the training of the operator on the virtual automation devices can be undertaken via an operator station server. An “operator station server” in the present instance is understood as a server that centrally acquires data of an operation and monitoring system and also as a rule acquires alarm and measured value archives of a control system of technical plant and makes them available to users. The operator station server as a rule establishes a communication link to automation systems of the technical plant and passes data of the technical plant to so-called operator station clients, which is used for operation and monitoring of a system for operation of the individual functional elements of the technical plant. The operator station server can have client functions available in order to access the data (archive, messages, tags, variables) of other operator station servers. This enables images of an operation of the technical plant to be combined on the operator station server with variables of other operator station servers (server-server communication). The operator station server can, without being restricted thereto, involve a Siemens SIMATIC PCS 7 Industrial Workstation Server.

In the present context, a control system is understood as a computer-assisted technical system that comprises functionalities for displaying, operating and controlling the technical plant. The control system can also comprise sensors for establishing measured values as well as various actuators. Moreover, the control system comprises “process” or “production-related” components that serve to actuate the actuator or sensors. Above and beyond this, the control system, inter alia, has means for visualization of the process engineering system and for engineering. The control system can optionally also comprise further processing units for more complex closed-loop controllers and systems for data storage and processing.

The objects and advantages are moreover achieved in accordance with the invention by a method comprising a) creating, by a computer-implemented tool, a first configuration for a first group of real automation devices used in the technical plant, b) allocating, by the computer-implemented tool, the first configuration to the first group of real automation devices used in the technical plant, c) transmitting, by the computer-implemented tool, the first configuration to the first group of real automation devices used in the technical plant, d) creating, by the computer-implemented tool, a second configuration for a group of real automation devices used in the technical plant differing from the first group, e) allocating, by the computer-implemented tool, the second configuration to the second group of real automation devices used in the technical plant, f) transmitting, by the computer-implemented tool, the configuration to the second of real automation devices used in the technical plant, g) additionally allocating, by the computer-implemented tool, the first configuration to a first group of virtual automation devices, h) transmitting, by the computer-implemented tool, the allocated first configuration to a computer-implemented virtualization environment, which provides the first group of virtual automation devices, i) additionally allocating, by the computer-implemented tool, the second configuration to the first group of virtual automation devices, and j) transmitting by the computer-implemented tool of the allocated first configuration to a computer-implemented virtualization environment, which provides the first group of virtual automation devices.

The first or the second configuration can be allocated additionally by the computer-implemented tool to a second group of virtual automation devices different from the first group, and the allocated first configuration or second configuration can be transmitted to the computer-implemented virtualization environment, which provides the first group and the second group of virtual automation devices.

Quite especially and preferably, the operator station server offers the first temporal course of the first alarm status belonging to the measured values and the second temporal course of the second alarm status belonging to the measured values or to the further measured values of the further technical object transmitted to the operator station client and the operator station client displays this visually to the operator of the technical plant in the common flow diagram.

The virtual automation devices can be operated by the computer-implemented virtualization environment by using the first, and where necessary the second, configuration.

The objects and advantages are additionally achieved in accordance with the invention by a use of the automation system in accordance with the invention for training of an operator of a technical plant.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The characteristics, features and advantages of this invention described above, as well as the manner in which these are achieved, will become clearer and easier to understand in conjunction with the following description of exemplary embodiments, which are explained in greater detail in conjunction with the drawings, in which:

FIG. 1 shows a first graphical plot of measured values over time;

FIG. 2 shows a second graphical plot of measured values over time; and

FIG. 3 is a flowchart of the method in accordance with the invention.

### DETAILED DESCRIPTION OF THE EXEMPLARY EMBODIMENTS

Explained below is an exemplary inventive computer-implemented tool and an example of its use for training an operator of a technical plant, such as a production or process plant. In these examples, it should be understood that the technical plant has the real (physically present) automation devices OS1, OS2, OS3, AS1, AS2 and AS3. Moreover, the automation system comprises a virtualization computer with a computer-implemented virtualization environment thereon. In this virtualization environment, the virtual automation devices OTS1_OS1, OTS2_OS1, OTS1_vAS1 and OTS2_vAS1 are provided.

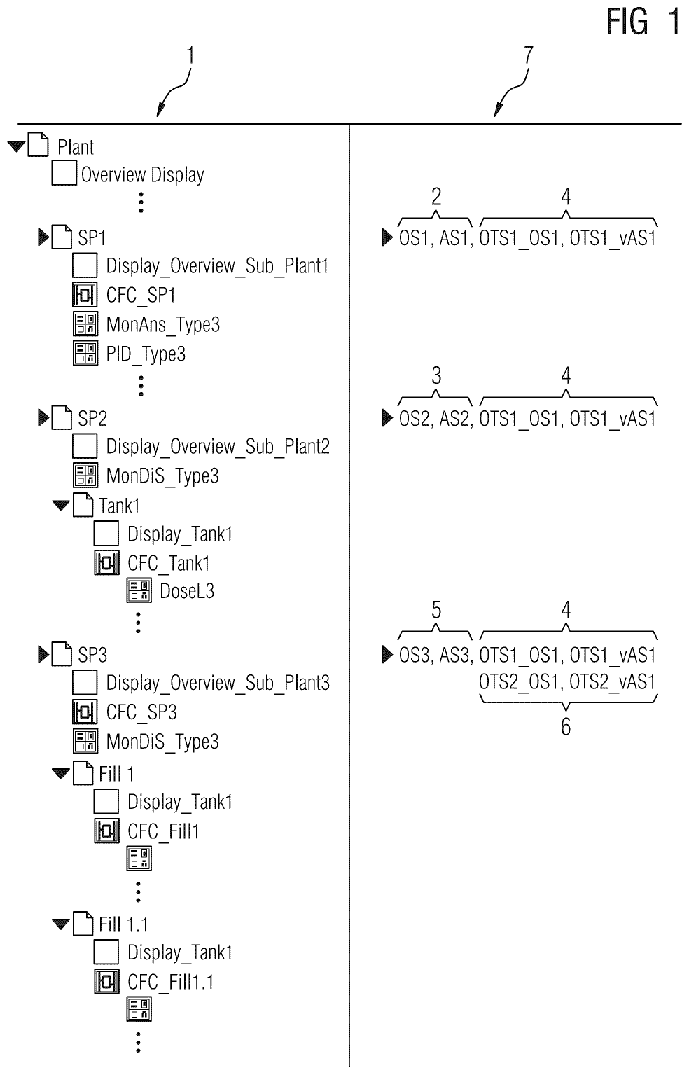

FIG. 1 shows an example of an assignment of configurations to the real and virtual automation devices. For this, configurations of three sub plants “SP1”, “SP2”, “SP3” are shown in a hierarchical diagram (in the “technological hierarchy”) in the left-hand column 1 of FIG. 1. The plant parts SP2 and SP3 in their turn have sub parts (“Tank1”, “Fill 1”, “Fill 1.1”). The configurations involve plant maps (“Display_Overview_Sub_Plant1”, “Display_Overview_Sub_Plant2”, “Display_Overview_Sub_Plant3”), process objects (“MonAnS_Type3”, “MonDiS_Type3”, “MonDiS_Type3”, “DoseL3”) and CFC-based plans (“CFC_SP1”, “CFC_Tank1”, “CFC_SP3”, “CFC_Fill1”, “CFC_Fill1.1”).

In the present exemplary embodiment, a first configuration, the configuration of the sub plant 1 (SP1), is allocated to a first group 2 of real automation devices (OS1 and AS1), which are depicted in the right-hand column 7 in FIG. 1. This means here that, in the CFCs, SFCs, etc. contained, processing is by AS1 and the plant maps are provided by OS1. A second configuration, the configuration of the sub plant 2 (SP2), is allocated to a second group 3 of real automation devices (OS2 and AS2).

The first configuration is moreover allocated to a first group 4 of virtual automation devices (OTS1_OS1, OTS1_vAS1). The second configuration is additionally also allocated to the first group of virtual automation devices (OTS1_OS1, OTS1_vAS1).

A third configuration, the configuration of the sub plant 3 (SP3), is allocated to a third group 5 of real automation devices (OS3 and AS3). The third configuration is moreover allocated to a first group 4 of virtual automation devices (OTS1_OS1, OTS1_vAS1) and to a second group 6 of virtual automation devices (OTS2_OS1, OTS2_vAS1).

The present invention enables the configurations, as well as the real, productive automation devices (which as before can only be allocated once to each plant part), to be allocated additionally to the virtual automation devices of the training systems—also several times and above all also differently.

Thus, for the training system OTS1, the sub plants SP1, SP2 and SP3 are merely allocated the virtual automation devices OTS1_OS1 and OTS1_vAS1, i.e., the training system is merely to use two devices (minimalistically). Furthermore, there is provision for another reduced training system, with the aid of which only scenarios of the sub plant 3 (SP3) are to be trained, where the virtual automation devices OTS2_OS1 and OST2_vAS1 are to be used for this. The flexible allocation of the components of the technological hierarchy to the real and virtual automation devices of the technical plant has the advantage that with the same technology minimalistic device configurations of the training systems can be addressed. In this way, for example, the virtual automation device OTS1_OS1 can be loaded directly from the central project planning, with the scope SP1, SP2 and SP3. The project planning here automatically maps the content to be loaded to the respective device configuration.

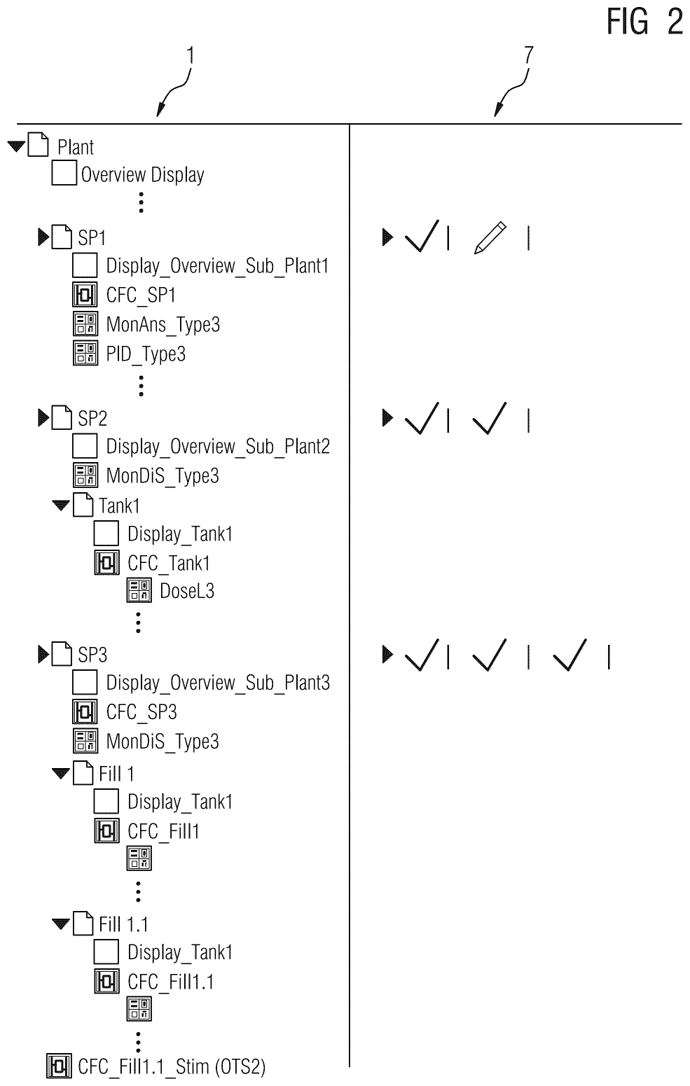

A further advantage of the invention is particularly obtained when the computer-implemented tool also depicts a load status during the transmissions of the configurations to the automation devices. Shown symbolically in FIG. 2 in the right-hand column 7 is the load state/transmission status that the individual configurations have as regards the individual automation devices. The first configuration of the first sub plant SP1 has been completely transmitted to the first group 2 of real automation devices (symbolized by a tick (or check mark), while it has not yet been completely transferred to the first group 4 of virtual automation devices (symbolized by a pencil).

The second configuration of the second sub plant SP2 has been completely transmitted to the second group 3 of real automation devices and to the first group 4 of virtual automation devices (symbolized by two ticks).

The third configuration of the third sub plant SP3 has been completely transmitted to the third group 5 of real automation devices, to the first group 4 and the second group 6 of virtual automation devices (symbolized by three ticks).

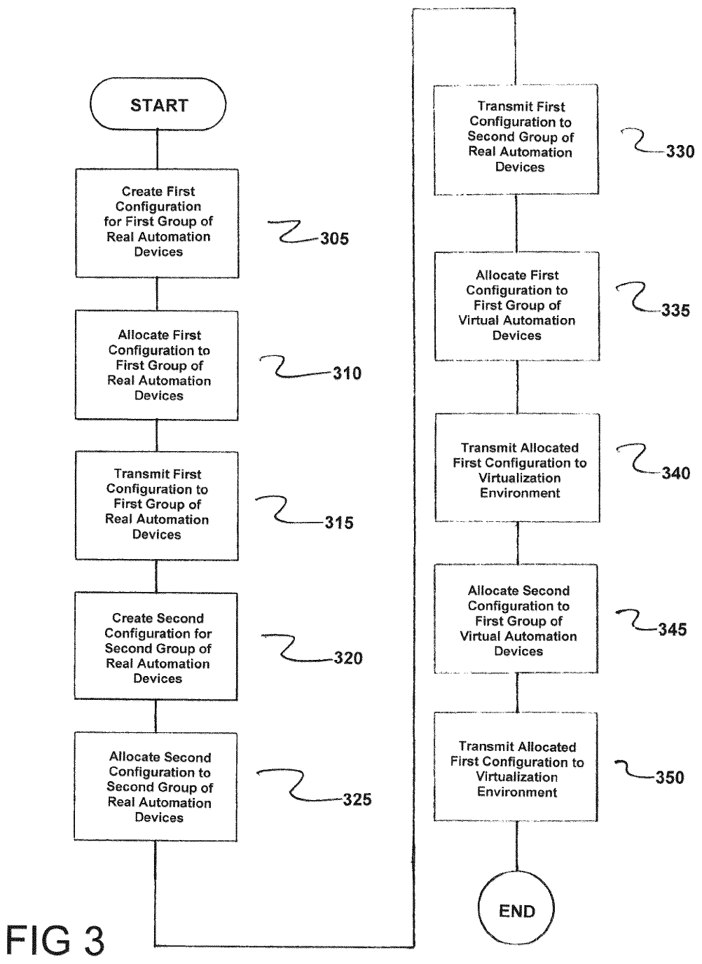

FIG. 3 is a flowchart of the inventive method. The method comprises a) creating, by a computer-implemented tool, a first configuration for a first group 2 of real automation devices utilized in a technical plant, as indicated in step 305.

Next, b) the computer-implemented tool allocates the first configuration to the first group 2 of real automation devices utilized in the technical plant, as indicated in step 310.

Next, c) the computer-implemented tool transmits the first configuration to the first group 2 of real automation devices utilized in the technical plant, as indicated in step 315.

Next, d) the computer-implemented tool creates a second configuration for a second group 3 of real automation devices utilized in the technical plant different from the first group 2, as indicated in step 320.

Next, e) the computer-implemented tool allocates the second configuration to the second group 3 of real automation devices utilized in the technical plant, as indicate in step 325.

Next, f) the computer-implemented tool transmits the first configuration to the second group 3 of real automation devices utilized in the technical plant, as indicated in step 330.

Next, g) the computer-implemented tool, additionally allocate the first configuration to a first group 4 of virtual automation devices, as indicated in step 335.

Next, h) the computer-implemented tool transmits the allocated first configuration to a computer-implemented virtualization environment, which provides the first group 4 of virtual automation devices, as indicated in step 340.

Next, i) the computer-implemented tool additionally allocates the second configuration to the first group 4 of virtual automation devices, as indicated in step 345.

Next, j) the computer-implemented tool transmits the allocated first configuration to a computer-implemented virtualization environment, which provides the first group 4 of virtual automation devices, as indicated in step 350.

Although the invention has been illustrated and described in greater detail by the preferred exemplary embodiment, the invention is not restricted by the disclosed examples and other variations can be derived herefrom by the person skilled in the art without departing from the scope of protection of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer-implemented tool for creating an automation for a technical plant comprising a process or production plant, the computer-implemented tool being configured to:
create a first configuration for a first group of real automation devices utilized in the technical plant to allocate the first configuration to the first group of real automation devices utilized in the technical plant and to transmit the first configuration to the first group of real automation devices utilized in the technical plant; and
create a second configuration for a second group of real automation devices utilized in the technical plant different from the first group to allocate the second configuration to the second group of real automation devices utilized in the technical plant and to transmit the second configuration to the second group of real automation devices utilized in the technical plant;
allocate the first configuration additionally to a first group of virtual automation devices and to transmit the allocated first configuration to a computer-implemented virtualization environment, which provides the first group of virtual automation devices; and
transmit the second configuration of the first group of virtual automation devices and the allocated first configuration to the computer-implemented virtualization environment, which provides the first group of virtual automation devices.

2. The computer-implemented tool as claimed in claim 1, wherein the computer-implemented tool is further configured to establish a status of a respective transmission of configurations to the real and virtual automation devices and represent said status visually.

3. The computer-implemented tool as claimed in claim 1, wherein the computer-implemented tool is further configured to allocate the first or the second configuration to a second group of virtual automation devices different from the first group and to transmit the allocated first configuration or second configuration to the computer-implemented virtualization environment, which provides the first group and the second group of virtual automation devices.

4. The computer-implemented tool as claimed in claim 2, wherein the computer-implemented tool is further configured to allocate the first or the second configuration to a second group of virtual automation devices different from the first group and to transmit the allocated first configuration or second configuration to the computer-implemented virtualization environment, which provides the first group and the second group of virtual automation devices.

5. The computer-implemented tool as claimed in claim 1, wherein the configurations comprise at least one of plant diagrams, Continuous Function Chart-Based (CFC-based) plans, Sequential Function Chart-Based (SFC-based) plans, process objects and connectivity objects.

6. An automation system, comprising:
an engineering station server including the computer-implemented tool as claimed in claim 1 implemented thereon; and
a virtualization computer including a computer-implemented virtualization environment thereon.

7. The automation system as claimed in claim 6, wherein the virtualization computer is configured to utilize configurations established by the engineering station server transmitted to the virtualization computer for operating the virtual automation devices.

8. A method, comprising:
a) creating, by a computer-implemented tool, a first configuration for a first group of real automation devices utilized in a technical plant;
b) allocating, by the computer-implemented tool, the first configuration to the first group of real automation devices utilized in the technical plant;
c) transmitting, by the computer-implemented tool, the first configuration to the first group of real automation devices utilized in the technical plant;
d) creating, by the computer-implemented tool, a second configuration for a second group of real automation devices utilized in the technical plant different from the first group;
e) allocating, by the computer-implemented tool, the second configuration to the second group of real automation devices utilized in the technical plant;
f) transmitting, by the computer-implemented tool, the first configuration to the second group of real automation devices utilized in the technical plant;
g) additionally allocating, by the computer-implemented tool, the first configuration to a first group of virtual automation devices;
h) transmitting, by the computer-implemented tool, the allocated first configuration to a computer-implemented virtualization environment, which provides the first group of virtual automation devices;
i) additionally allocating, by the computer-implemented tool, the second configuration to the first group of virtual automation devices; and
j) transmitting, by the computer-implemented tool, the allocated first configuration to a computer-implemented virtualization environment, which provides the first group of virtual automation devices.

9. The method as claimed in claim 8, wherein the first or the second configuration is additionally allocated by the computer-implemented tool to a second group of virtual automation devices different from the first group, and the allocated first configuration or second configuration is transmitted to the computer-implemented virtualization environment, which provides the first group and the second group of virtual automation devices.

10. The method as claimed in claim 8, wherein the virtual automation devices are operated by the computer-implemented virtualization environment utilizing the first, and where necessary the second, configuration.

11. The method as claimed in claim 9, wherein the virtual automation devices are operated by the computer-implemented virtualization environment utilizing the first, and where necessary the second, configuration.

12. The automation system as claimed in claim 6, wherein the automation system is utilized to train an operator of the technical plant.
